(19) United States
(12) Patent Application Publication
(10) Pub. No.: US 2024/0164615 A1
(43) Pub. Date: May 23, 2024

(54) INDUSTRIAL HANGING MAGNETIC SWEEPER APPARATUS

(71) Applicant: Bluestreak Equipment Inc., Delhi (CA)

(72) Inventors: Emmett TOWNSEND, Paris (CA); Brian WEBER, Delhi (CA)

(21) Appl. No.: 18/518,161

(22) Filed: Nov. 22, 2023

Related U.S. Application Data
(60) Provisional application No. 63/427,447, filed on Nov. 22, 2022.

(51) Int. Cl. A47L 13/41; B03C 1/30

(52) U.S. Cl. CPC A47L 13/41; B03C 1/30

(57) ABSTRACT

An industrial hanging magnetic sweeper apparatus auto clean-off, side shift and height adjustment features. The magnetic sweeper apparatus mounts to an industrial vehicle using chains and maintains multiple points of contact. This allows movement of the apparatus independently from the vehicle which reduces damage to the apparatus and the vehicle in the case of incidental ground contact. The apparatus includes a hydraulic side shift of the magnet allowing debris to be collected from outside the primary mover track width. The apparatus also allows for height adjustment on each individual side. Two top links, one for each side, can adjust the sweeping height of the magnetic sweeper for optimal pickup performance.

### CROSS REFERENCE TO RELATED APPLICATIONS

This application claims priority to and the benefit of U.S. Provisional Application Ser. No. 63/427,447, entitled “INDUSTRIAL HANGING MAGNETIC SWEEPER APPARATUS”, filed on Nov. 22, 2022, the disclosure of which is incorporated herein by reference in its entirety.

### BACKGROUND

The field of the disclosure relates to sweeper apparatuses, in particular to a magnetic sweeper apparatus.

This disclosure addresses the need for a large and robust permanent magnet that can hang from heavy equipment, or vehicles. Specifically, no industrial sized permanent magnetic sweepers exist in today's market offering features that will withstand industrial environments and day to day operations. This disclosure addresses reducing the possibility of excessive damage to the primary mover or to the sweeper itself with repeated use in the heavy equipment environment.

This disclosure also addresses the problem with picking up debris from outside the tire track of motor grading equipment (or other vehicles it is mounted to), while not being wider than the primary mover itself. This disclosure allows for a reliable and convenient solution to cleaning off the metal debris that has been collected through normal operation. Worker safety is of utmost importance, so this disclosure allows workers to remain safe while operating this disclosure.

### BRIEF DESCRIPTION OF THE DRAWINGS

FIG. 1 is a line diagram of a perspective view of an exemplary hanging magnetic sweeper.

FIG. 2 is a line diagram of a top view of an exemplary hanging magnetic sweeper.

FIG. 3 is a line diagram of a front view of an exemplary hanging magnetic sweeper.

FIG. 4 is a line diagram of a right-side view of an exemplary hanging magnetic sweeper.

FIG. 5 is a line diagram of a perspective view of an exemplary hanging magnetic sweeper mounted on a vehicle.

FIG. 6 is a diagram illustrating a front view of a clean-off.

FIG. 7 is a diagram illustrating right-side view of a clean-off with debris.

FIG. 8A is a diagram illustrating sweep height adjustment.

FIG. 8B is a diagram illustrating a perspective view of the height adjustment assembly.

FIG. 9A is a diagram illustrating side shift accessory details.

FIG. 9B is a diagram illustrating a perspective view of side shift accessory of the height adjustment assembly.

FIG. 10 is a diagram that illustrates the Gauss (G) measurements for the magnetic strength of the magnetic sweeper.

### SUMMARY

An industrial hanging magnetic sweeper apparatus with auto clean-off, side shift and height adjustment features. The magnetic sweeper apparatus mounts to an industrial vehicle using chains and maintains multiple points of contact. This allows movement of the apparatus independently from the vehicle which reduces damage to the apparatus and the vehicle in the case of incidental ground contact. The apparatus includes a hydraulic side shift of the magnet allowing debris to be collected from outside the primary mover track width. The apparatus also allows for height adjustment on each individual side. Two top links, one for each side, can adjust the sweeping height of the magnetic sweeper for optimal pickup performance.

### DETAILED DESCRIPTION

This disclosure is a large permanent magnet that can be attached to the front or rear of a vehicle with various value-added features. It features a compact main frame which provides structure for raising and lowering a large permanent magnet within itself. One or more hydraulic cylinders on the magnetic sweeper can lift and lower the magnet contained within the main corrugated steel frame. When connected to the primary mover auxiliary hydraulics, this function allows the magnet to be cleaned off from within the cab of the primary mover, using its in-cab controls.

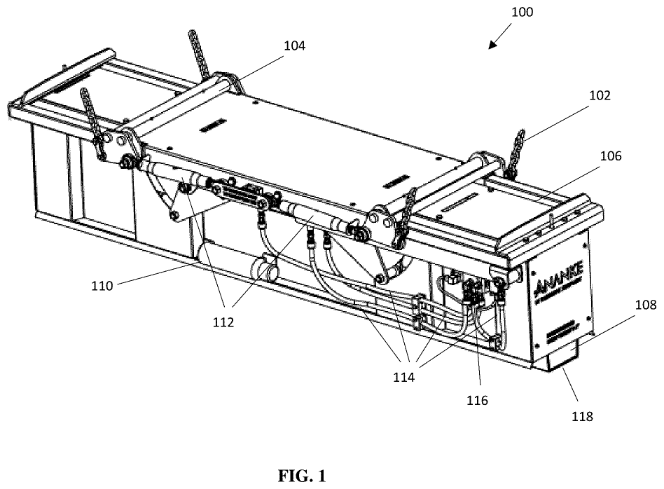

FIGS. 1 to 4 are line diagrams that illustrate different views of an exemplary hanging magnetic sweeper. FIG. 1 is a line diagram of a perspective view of an exemplary hanging magnetic sweeper. According to FIG. 1, hanging magnetic sweeper 100 consists of steel chain 102, steel pivot 104, steel frame and/or magnet cover 106. Steel chain 102 can be a ⅜″ Grade 70 steel chain and there can be four of them hung to an industrial vehicle. Steel pivot 104 is used for height adjustment of the magnetic sweeper. Steel frame/magnet cover 106 is on the top and on both ends of hanging magnetic sweeper 100.

According to FIG. 1, hanging magnetic sweeper 100 further comprises magnet 108, manual holder 110, forged top links 112, hydraulic hoses 114 and hydraulic flow diverter 116. Forged top links 112 provides height adjustment on each side of the sweeper 100 and allows to raise and lower the sweeper to achieve desired metallic debris pickup performance and adjust the ‘levelness’ of the sweeper after it has been mounted to the vehicle. Magnet 108 is a continuous bar Ceramic8 magnet with dimensions of 6″ width by 6″ height by 94.5″ length.

According to FIG. 1, four hydraulic hoses 114 are shown; two of these are used for magnet clean off and two are used for side shift. Hydraulic flow diverter 116 allows for individual control of magnet clean off, or side shift functions, when connected to the auxiliary hydraulics system on the vehicle. According to FIG. 1, magnet 108 further comprises a metallic bottom pan 118 configured as the bottom surface of the magnet 108 for magnetic attachment of metallic debris.

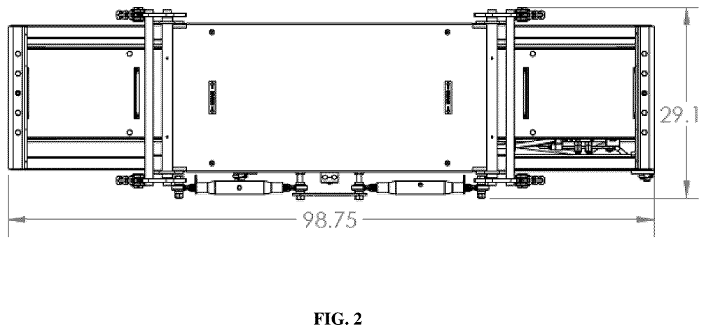

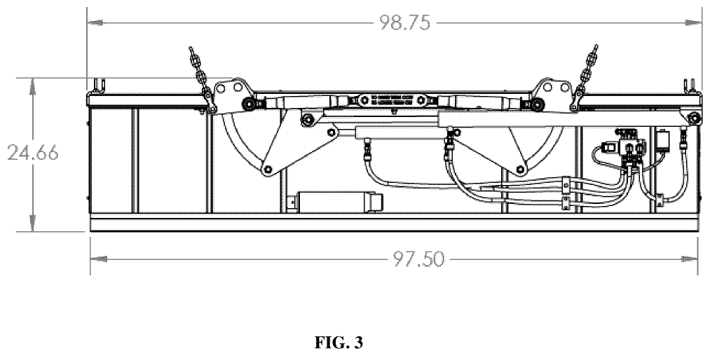

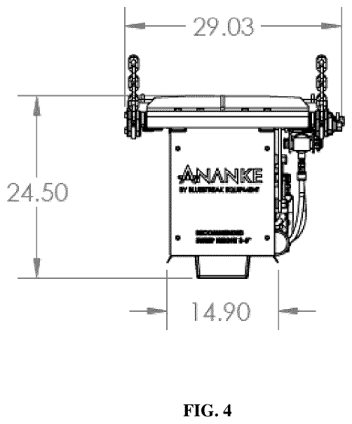

FIG. 2 is a line diagram of a top view of an exemplary hanging magnetic sweeper. FIG. 3 is a line diagram of a front view of an exemplary hanging magnetic sweeper. FIG. 4 is a line diagram of a right-side view of an exemplary hanging magnetic sweeper. The overall dimensions of the magnetic sweeper are 98.75″ length by 24.5″ width by 29.1″ depth (or height) in the direction of travel (i.e., forwards or backwards). According to FIG. 4, the width of steel frame containing the magnet assembly is 14.90″.

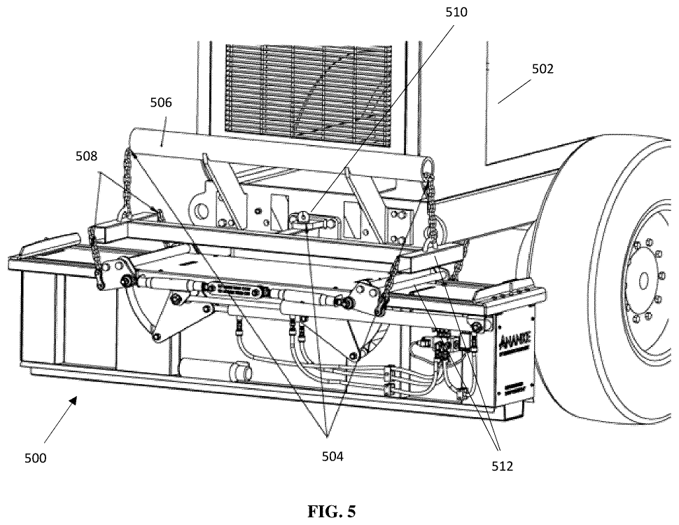

FIG. 5 is a line diagram of a perspective view of an exemplary hanging magnetic sweeper mounted on a vehicle. According to FIG. 5, the hanging magnetic sweeper 500 can be mounted on the front or back of an industrial vehicle 502 or mounted behind a motor grader (e.g., Caterpillar 140M Motor Grader). Other industrial vehicles (or heavy equipment) that the hanging magnetic sweeper 500 could be mounted on include forklifts, loaders and backhoes. The hanging magnetic sweeper 500 connects to the industrial vehicle using a 3-point contact 504 utilizing a rear pin and 2 corners on a bash bar 506. The bash bar can be a CAT 140M rear bash bar. According to FIG. 5, hanging magnetic sweeper 500 further comprises grade chain 508 used to hang the magnetic sweeper 500. Grade chain 508 can be a 0.5″ grade 70 chain.

According to FIG. 5, the connection to the industrial vehicle 502 is via a set of four grade chains 508 that hang from the top of the magnetic sweeper 500. Some fabrication work may be required to allow the sweeper to hang in a structurally sound way. It maintains 3 points of contact (504), utilizing the rear impact bash bar 506 and the rear pin 510. According to FIG. 5, grade chain 508 connects magnetic sweeper 500 to bash bar 506 using a manual height adjustment assembly 512.

According to further embodiments, alternate mounting methods may be considered. For example, the chains may be removed altogether and the same holes the chains mount to may be used to permanently attach the sweeper to the industrial vehicle 502.

The magnetic sweeper incorporates “wrap around” technology which ensures debris is retained on the magnet surface when the ground or other obstacles are struck. When the ground is hit, debris that has been picked up will simply be wiped to the front or rear face of the magnet depending on the direction of travel and will not be wiped off the magnet. A chain is used to hang the sweeper from the primary mover, which provides some slack for when the ground or other obstacles are stuck, reducing damage to the sweeper, and thus the primary mover as well.

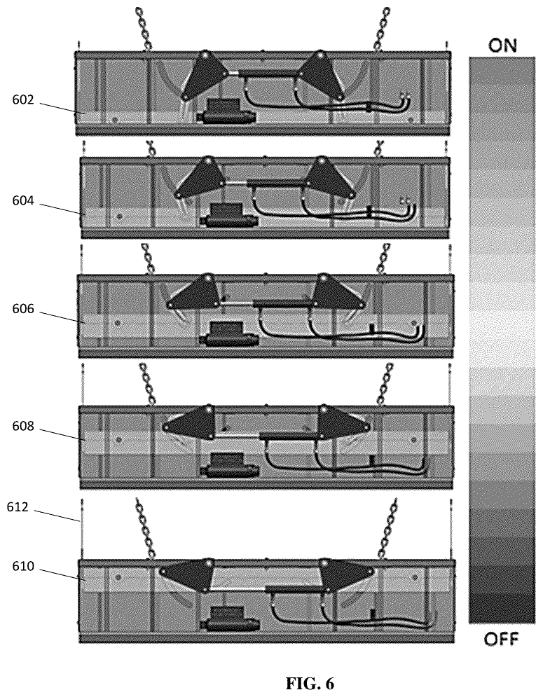

FIG. 6 is a diagram of a front view illustrating clean-off. According to FIG. 6, the bottom to top gradient depicts the Magnet Off to Magnet On sequence as the hydraulic are actuated. The set of four links work in unison as the hydraulics are actuated, similar to a scissor style lift mechanism.

According to FIG. 6, magnets 602, 604, 606, 608 and 610 are shown to rise via hydraulic actuation. The raising of the magnet allows metallic debris to fall off. According to FIG. 6, magnetic sweeper is also shown with a FRP marker 612 that provides a visual line of sight for the operator of the vehicle to know the approximate outer limits of the attachment.

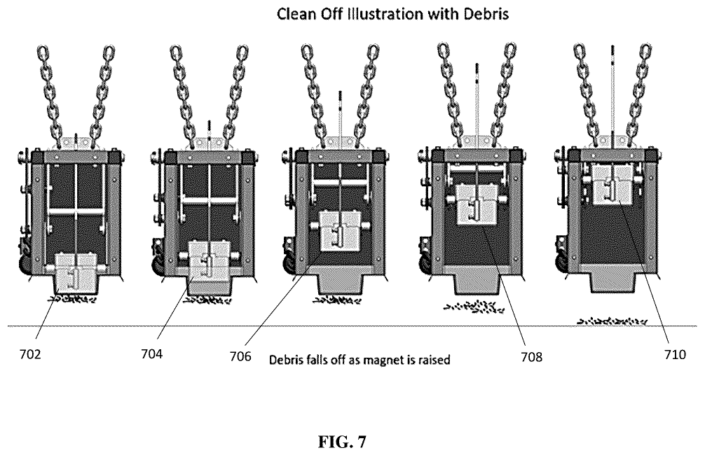

FIG. 7 is a diagram illustrating a right-side view of clean-off with debris. According to FIG. 7, several illustrations are shown with the magnetic sweeper holding debris in the left image to the magnetic sweeper having no debris in the right image. According to FIG. 7, magnets 702, 704, 706, 708 and 710 are shown to be lifted using hydraulic actuation. As the magnet is raised, metallic debris that clings onto the bottom pan of the magnet falls off as the magnet is raised in the sequence of five images. The lifting of the magnet creates separation where gravity is stronger than the weaker magnetic force, thus allowing the debris to fall to the ground.

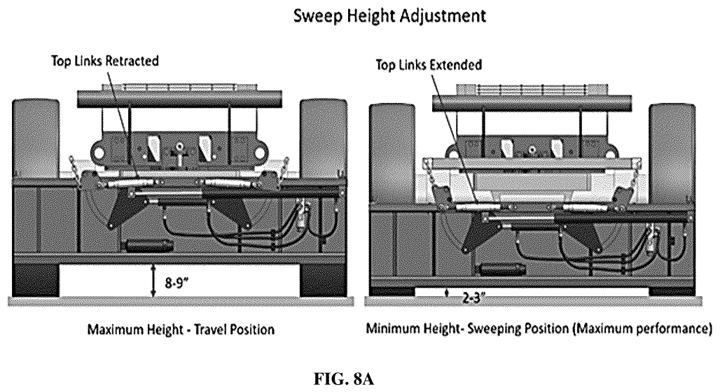

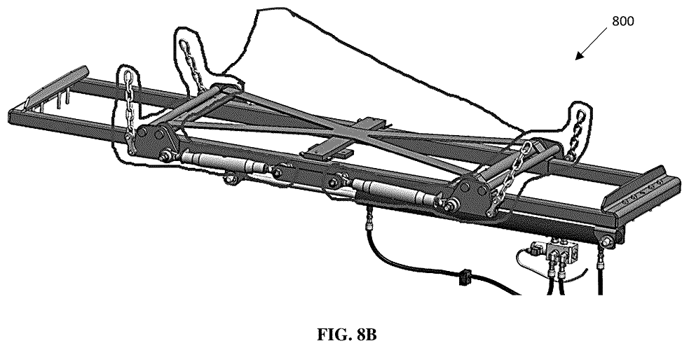

FIG. 8 is a diagram illustrating sweep height adjustment. According to FIG. 8, the height adjustment feature allows the sweeper to be raised if the vehicle is planning to travel over rough terrain, up a ramp or over large bumps. According to FIG. 8, the top links can be retracted or extended to increase to 8-9″ and retracted to decrease the deck clearance to 2-3″.

FIG. 8B is a diagram illustrating a perspective view of the height adjustment assembly. According to FIG. 8B, height adjustment assembly 800 is shown when top links 802 and 804 are extended, the steel pivots 806 and 808 rotate, lowering the assembly 800. And vice versa, when retracted, pivots 806 and 808 rotate, raising the assembly 800.

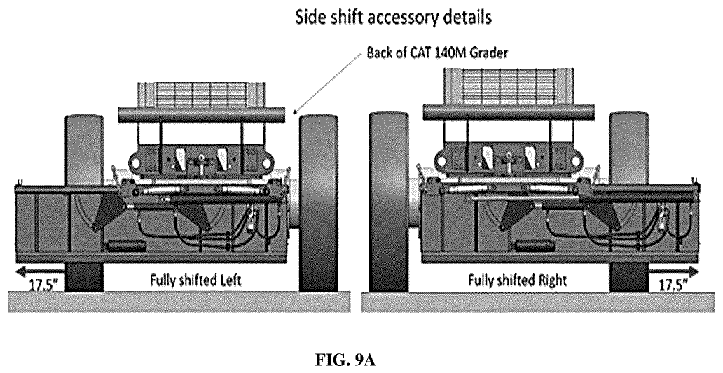

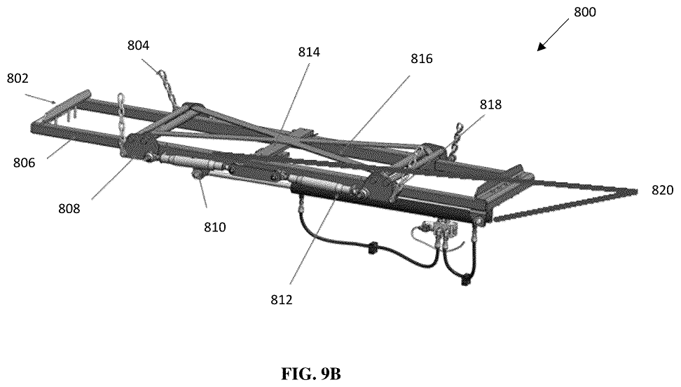

FIG. 9A is a diagram illustrating side shift accessory details. According to FIG. 9, the side shift accessory will enable the magnetic sweeper to fully shift left or right. The magnet will reach 17.5″ outside the motor grader wheelbase (i.e., industrial vehicle) when mounted centered (based on the CAT 140M vehicle).

According to FIG. 9A, the side shift bracket allows for 36″ of side-to-side movement. This allows for 17.75″ of reach outside the limits of the tires. The bracket can also be mounted off center to achieve more reach on one side of the motor grader; for example, 24″ to the left of the vehicle and 12″ to the right.

FIG. 9B is a diagram illustrating a perspective view of side shift accessory of the height adjustment assembly. According to FIG. 9B, height adjustment assembly 900 is shown comprising ⅜″ thick end plates 902, steel chain 904 (i.e., 13 Ton break strength grade 70 chain), square steel tube 906 having dimensions of 2″×0.1875″, ½″ thick steel plates 908, 1⅛″ thread forged top link 910 (for height adjustment), 35000 psi max hydraulic cylinder 912 (with 2″ bore), ¼″ solid steel slider 914, ¼″ thick x-brace 916, twin clevis 918 ( 7/16″-½″ grade 70) and side shift accessory 920. Side shift accessory 920 consists of cylinders that push on the center frame which allow the frame to move horizontally.

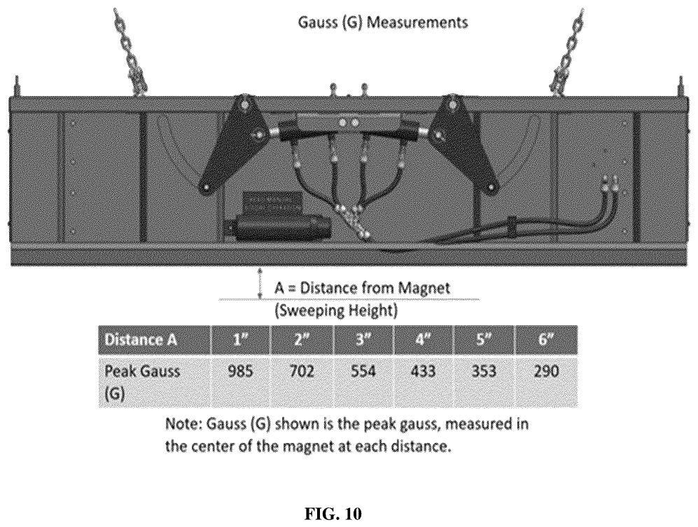

FIG. 10 is a diagram that illustrates the Gauss (G) measurements for the magnetic strength of the magnetic sweeper. According to FIG. 10, sweeping height A is the distance from the magnet. The following table (also shown in FIG. 10) illustrates the relationship between sweeping height and magnet strength (in Gauss):

| Distance A | 1″ | 2″ | 3″ | 4″ | 5″ | 6″ |
|---|---|---|---|---|---|---|
| Project | 985 | 702 | 554 | 433 | 353 | 290 |
| Gauss (G) | | | | | | |

According to FIG. 10, the closer the sweeping height (Distance A), the stronger the magnetic force and the larger the sweeping height, the smaller the magnetic strength. For example, at 1″, the magnetic strength is 985 G and at 6″, the magnetic strength is 290 G.

The disclosure includes hydraulic side shift of the magnet allowing debris to be collected from outside the primary mover track width. This solves the issues motor graders have with not being able to pick up metal debris in the windrow that comes off the motor grader blade.

This disclosure also allows for height adjustment on each individual side. Two top links, one for each side, can adjust the sweeping height of the magnetic sweeper for optimal pickup performance.

This disclosure is suspended by chain, which allows movement of the disclosure independently from the prime mover which reduces damage to the disclosure and prime mover in the case of incidental ground contact.

According to the disclosure, materials that make up the industrial hanging magnet include steel, stainless steel, UHMW and ABS plastic, fibre reinforced plastic (FRP), rubber and copper (for wiring only). Other suitable materials further include other types of metals (e.g., aluminum, titanium, etc.) and other types of plastics (e.g., HDPE, Delrin, other thermoplastics). Rubber hoses could be substituted with braided metal hoses. FRP markers can be replaced with stainless steel, fibreglass or other plastic material.

According to the disclosure, the magnet is made from C8 ceramic magnet blocks. The magnet assembly (or housing for the magnet) is constructed of steel and/or stainless steel. The magnet assembly could be made from other materials including aluminum, titanium or fiberglass.

The overall compact folding design of the magnet lift system and main frame makes it a unique disclosure.

It may be possible to accomplish the same goals by creating a different mounting mechanism for a permanent magnet, or a different lifting mechanism for automatic clean off, or a new system that does not shift side to side, but instead flip down away from the center of the primary mover to reach out past the width of the tires.

Electromagnets exist and create a similar result to permanent magnets; however they require auxiliary power to work, and do not provide magnetic strength characteristics that are comparable to permanent magnets regarding physical size.

According to the disclosure, a hanging magnetic sweeper apparatus, configured for attachment to an industrial vehicle for magnetic sweeping of metallic debris is disclosed. The apparatus comprising a frame, an attachment bracket configured for attachment of the frame to the industrial vehicle, a hanging magnet housed within the frame, a metallic bottom pan configured as the bottom surface of the hanging magnet configured for magnetic attachment of metallic debris, a plurality of steel chains for hanging the apparatus to the attachment bracket and the industrial vehicle and a hydraulic assembly configured for moving the hanging magnetic from a sweeping position to a clean-off position.

According to the disclosure, in the sweeping position of the apparatus, the magnet is lowered close to the ground and metallic debris is collected at the bottom pan using magnetic force and in a clean off position, the magnet is lifted vertically thereby creating a weaker magnetic force, allowing gravity to clean off the metallic debris away from magnetic sweeper apparatus.

According to the disclosure, the attachment bracket of the apparatus connects to a bash bar of the industrial vehicle. The hanging magnetic sweeper connects to the industrial vehicle using a 3-point contact utilizing a rear pin and 2 corners on the bash bar. The apparatus further comprising a steel pivot used for height adjustment of the magnetic sweeper.

According to the disclosure, the apparatus further comprising a magnet cover on the top and on both ends of the hanging magnetic sweeper. The steel chain is a ⅜″ Grade 70 steel chain and wherein four steel chains are hung from the industrial vehicle. The apparatus further comprising a manual holder and a FRP marker, the FRP marker providing a visual line of sight for the operator of the vehicle to know the approximate outer limits of the apparatus.

According to the disclosure, the hydraulic assembly of the apparatus further comprises forged top links, hydraulic hoses and a hydraulic flow diverter. The forged top links provide height adjustment on each side of the sweeper and allow the sweeper to be raised and lowered to achieve desired metallic debris pickup performance and allow the levelness of the sweeper to be adjusted after it has been mounted to the vehicle. Furthermore, the forged top links can be retracted or extended to increase to 8-9″ and retracted to decrease the deck clearance to 2-3″.

According to the disclosure, the apparatus further comprising four hydraulic hoses, wherein two of these hoses are used for magnet clean off and two are used for side shift movement. The hydraulic flow diverter allows for individual control of magnet clean off, or side shift functions, when connected to the auxiliary hydraulics system on the vehicle.

According to the disclosure, the magnet is a continuous bar Ceramic8 magnet with dimensions of 6″ width by 6″ height by 94.5″ length. The dimensions of the magnetic sweeper are 98.75″ length by 24.5″ width by 29.1″ height in the forward or backward direction of travel.

According to the disclosure, the hanging magnetic sweeper can be mounted on the front or back of an industrial vehicle, wherein the industrial vehicle is selected from a list consisting of a motor grader, a forklift, a loader and a backhoe. The height adjustment feature allows the apparatus to be raised if the vehicle is planning to travel over rough terrain, up a ramp or over large bumps. Furthermore, the metallic bottom pan of the apparatus is a stainless-steel pan or an aluminum pan.

According to the disclosure, a method of removing metallic debris, using a hanging magnetic sweeper attachment on an industrial vehicle is disclosed. The method comprises the steps of placing the magnetic sweeper attachment in sweeping position, the magnetic sweeper attachment further comprising a frame, a hydraulic assembly, a connecting mechanism and a hanging magnet, attracting metal debris at the bottom of the metallic pan of the magnetic sweeper attachment and placing the magnetic sweeper attachment into a vertical clean off position. In a vertical clean off position, the magnet is lifted vertically hereby creating a weaker magnetic force, allowing gravity to clean off the metallic debris away from magnetic sweeper attachment and having the metallic debris fall to the ground. Furthermore, the movement of the hanging magnet of the magnetic sweeper attachment is driven by hydraulic means.

According to the disclosure, the hydraulic assembly of the method further comprises forged top links, hydraulic hoses and a hydraulic flow diverter. The forged top links provides height adjustment on each side of the sweeper and allows the sweeper to be raised and lowered to achieve desired metallic debris pickup performance and the levelness of the sweeper to be adjusted after it has been mounted to the vehicle.

While some embodiments or aspects of the present disclosure may be implemented in fully functioning mechanical, electrical and electrical-mechanical systems, other embodiments may be considered.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The specific embodiments described above have been shown by way of example and understood is that these embodiments may be susceptible to various modifications and alternative forms. Further understood is that the claims are not intended to be limited to the forms disclosed, but to cover all modifications, equivalents, and alternatives falling within the spirit and scope of this disclosure. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, various changes and modifications in form, material, workpiece, and fabrication material detail may be made, without departing from the spirit and scope of the present disclosure, as set forth in the appended claims, as may be apparent to those of ordinary skill in the art, are also encompassed by the present disclosure.

What is claimed is:

1. A hanging magnetic sweeper apparatus, configured for attachment to an industrial vehicle for magnetic sweeping of metallic debris, the apparatus comprising:
a frame;
an attachment bracket configured for attachment of the frame to the industrial vehicle;
a hanging magnet housed within the frame;
a metallic bottom pan configured as the bottom surface of the hanging magnet configured for magnetic attachment of metallic debris;
a plurality of steel chains for hanging the apparatus to the attachment bracket and the industrial vehicle; and
a hydraulic assembly configured for moving the hanging magnetic from a sweeping position to a clean-off position;
wherein in the sweeping position, the magnet is lowered close to the ground and metallic debris is collected at the bottom pan using magnetic force;
wherein in a clean off position, the magnet is lifted vertically thereby creating a weaker magnetic force, allowing gravity to clean off the metallic debris away from magnetic sweeper apparatus.

2. The apparatus of claim 1 wherein the attachment bracket connects to a bash bar of the industrial vehicle.

3. The apparatus of claim 2 wherein the hanging magnetic sweeper connects to the industrial vehicle using a 3-point contact utilizing a rear pin and 2 corners on the bash bar.

4. The apparatus of claim 1 further comprising a steel pivot used for height adjustment of the magnetic sweeper.

5. The apparatus of claim 1 further comprising a magnet cover on the top and on both ends of the hanging magnetic sweeper.

6. The apparatus of claim 1 wherein the steel chain is a ⅜″ Grade 70 steel chain and wherein four steel chains are hung from the industrial vehicle.

7. The apparatus of claim 1 further comprising a manual holder and a FRP marker, the FRP marker providing a visual line of sight for the operator of the vehicle to know the approximate outer limits of the apparatus.

8. The apparatus of claim 1 wherein the hydraulic assembly further comprises forged top links, hydraulic hoses and a hydraulic flow diverter.

9. The apparatus of claim 8 wherein the forged top links provide height adjustment on each side of the sweeper and allow the sweeper to be raised and lowered to achieve desired metallic debris pickup performance and allow the levelness of the sweeper to be adjusted after it has been mounted to the vehicle.

10. The apparatus of claim 8 wherein the forged top links can be retracted or extended to increase to 8-9″ and retracted to decrease the deck clearance to 2-3″.

11. The apparatus of claim 8 further comprising four hydraulic hoses, wherein two of these hoses are used for magnet clean off and two are used for side shift movement.

12. The apparatus of claim 8 wherein the hydraulic flow diverter allows for individual control of magnet clean off, or side shift functions, when connected to the auxiliary hydraulics system on the vehicle.

13. The apparatus of claim 1 wherein the magnet is a continuous bar Ceramic8 magnet with dimensions of 6″ width by 6″ height by 94.5″ length.

14. The apparatus of claim 1 wherein the dimensions of the magnetic sweeper are 98.75″ length by 24.5″ width by 29.1″ height in the forward or backward direction of travel.

15. The apparatus of claim 1 wherein the hanging magnetic sweeper can be mounted on the front or back of an industrial vehicle, wherein the industrial vehicle is selected from a list consisting of a motor grader, a forklift, a loader and a backhoe.

16. The apparatus of claim 1 wherein the height adjustment feature allows the apparatus to be raised if the vehicle is planning to travel over rough terrain, up a ramp or over large bumps.

17. The apparatus of claim 1 wherein the metallic bottom pan is a stainless-steel pan or an aluminum pan.

18. A method of removing metallic debris, using a hanging magnetic sweeper attachment on an industrial vehicle, the method comprising the steps of:
placing the magnetic sweeper attachment in sweeping position, the magnetic sweeper attachment further comprising a frame, a hydraulic assembly, a connecting mechanism and a hanging magnet;
attracting metal debris at the bottom of the metallic pan of the magnetic sweeper attachment; and
placing the magnetic sweeper attachment into a vertical clean off position;
wherein in a vertical clean off position, the magnet is lifted vertically hereby creating a weaker magnetic force, allowing gravity to clean off the metallic debris away from magnetic sweeper attachment and having the metallic debris fall to the ground;
wherein the movement of the hanging magnet of the magnetic sweeper attachment is driven by hydraulic means.

19. The method of claim 18 wherein the hydraulic assembly further comprises forged top links, hydraulic hoses and a hydraulic flow diverter.

20. The method of claim 19 wherein the forged top links provides height adjustment on each side of the sweeper and allows the sweeper to be raised and lowered to achieve desired metallic debris pickup performance and the levelness of the sweeper to be adjusted after it has been mounted to the vehicle.
